(19) United States
(12) Patent Application Publication
(10) Pub. No.: US 2008/0056064 A1
(43) Pub. Date: Mar. 6, 2008

(54) Method and Apparatus for Producing Dope, and Method for Producing Film

(75) Inventor: Hiromasa Tanaka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/659,701

(22) PCT Filed: Jul. 28, 2005
(86) PCT No.: PCT/JP05/14260

§ 371 Date: Feb. 8, 2007

(30) Foreign Application Priority Data
Aug. 9, 2004 (JP) 2004-232542

(51) Int. Cl. B01F 5/06

(52) U.S. Cl. 366/339

(57) ABSTRACT

An inline mixing device (53) is constituted of a sulzer mixer (160) disposed in an upper stream and a static mixer (170) disposed in a downstream. An additive supplied through an orifice (150a) passes through the sulzer mixer (160) disposed in the upstream. As the sulzer mixer (160) is superior in dividing the flow, the additive is uniformly dispersed in a dope pipe (152). Thereafter, the additive passes through the static mixer (170). As the static mixer (170) is superior in reversing the flow, the additive and the primary dope are further stirred and kneaded. The inline mixing device (53) uses the two different kinds of mixers for effectively mixing the additive and the dope while taking advantages of each mixer.

### TECHNICAL FIELD

The present invention relates to a method and an apparatus for producing a dope. More specifically, the present invention relates to the method and the apparatus for producing the dope which is used for producing a polymer film of optical applications such as an LCD and the like. Further, the present invention relates to a method for producing a film, which uses the dope produced by the method and apparatus for producing the dope.

### BACKGROUND ART

Various polymers are used for producing optical polymer films. In particular, a cellulose acylate film is one of the widely used films, which has transparency, proper moisture permeability, large mechanical strength, and low dependency of the dimensional stability on humidity and temperature.

An LCD is provided with a polarizing filter and an optical compensation film, and the polarizing filter often has a structure in which a polarized film is sandwiched between two protective films. Recently, there are cases where the optical compensation film is substituted for one of the protective films. It is known that cellulose acylate film doubles as the protective film and the optical compensation film by providing extreme optical properties.

The LCD is increasing in demand as the display device for an LCD television, and high luminance, large screen size and high image quality are desired. In achieving the high quality of the LCD, there arises a problem that even a slight unevenness in mixing the additives, which relates to the present invention, becomes apparent.

When producing the cellulose acylate, a solution casting method is often used. In the solution casting method, a polymer and a solvent are mixed as a primary dope, and various additives, for instance, plasticizers, UV-absorbing agents, matting agents, retardation control agents and the like, are added to the primary dope to produce the dope. The dope is cast from a die to a support, peeled off from the support upon obtaining self supporting property, and dried in a drying process. The support is a drum or a belt which is continuously rotated and transported.

In the production of the dope, after the additives are added to the primary dope, the additives and the dope are stirred and mixed using an inline mixer. As for the inline mixer, a static mixer, a sulzer mixer and the like are used. The static mixer is a mixer of a radial mixing type, which distorts and mixes a flow in a pipe using elements formed by twisting rectangular plates. The sulzer mixer is a mixer of a divide-and-mix type, which divides the flow in the pipe into plural flows using elements formed by plural thin intersecting plates.

When the dope is not uniform due to insufficient stirring, the grade of the product is declined. Therefore, various improvements are devised to ensure sufficient stirring. For instance, Japanese Patent Application No. 2003-282937 suggests a method for obtaining a uniform dope by controlling heating conditions of the inline mixer and pressure applied to the dope. Further, Japanese Patent Laid-Open Publication No. 2003-53752 discloses an example in which an orifice of the additive is placed close to the inline mixer.

As described above, since the configuration of the elements differs according to the type of the inline mixer, the advantage also differs according to the type of the inline mixer. For instance, the static mixer is superior in the reversal effect by the distortion and the sulzer mixer is superior in the dividing effect. However, conventionally, only one type of the inline mixer was used, which was selected from the plural types of inline mixers according to a sort of a dope to be produced. Therefore, it was difficult to achieve sufficient stirring. To achieve sufficient stirring, it is necessary to increase the number of elements, which results in upsizing and cost increase of the manufacturing process.

An object of the present invention is to provide a dope production method which enables efficient stirring.

### DISCLOSURE OF INVENTION

In order to achieve the object and the other object, in a dope production method of the present invention, two inline mixers, which differ in mixing manners, are connected in series for mixing a primary dope and an additive while transporting the primary dope and the additive.

It is preferable to dispose at least one of a static mixer and a sulzer mixer as the inline mixer. The static mixer of a radial mixing type has plural first elements formed of twisted partition members in a pipe for transporting the primary dope and the additive. The number of elements in the static mixer is preferably from 6 to 90, and more preferably from 6 to 60. A sulzer mixer of a divide-and-mix type has plural second elements formed of thin intersecting partition members in the pipe.

When both the static mixer and the sulzer mixer are disposed, it is preferable to dispose the sulzer mixer in an upstream of the static mixer. Further, a distance between the sulzer mixer and a position for adding the additive is preferably from 5 mm to 150 mm. Furthermore, the distance between the sulzer mixer and the position for adding the additive is more preferably from 5 mm to 15 mm.

It is preferable to incline partition members of an extreme upstream element of the sulzer mixer in a lengthwise direction for 45 degrees with respect to a vertical direction of a pipe when observed from the upstream of the pipe through which the dope passes. Further, it is preferable to dispose an upper lateral portion of the element constituting the sulzer mixer close to the inner walls of the pipe.

Further, it is preferable to dispose a first filtration device in the upstream of the inline mixer for filtering the primary dope, and add the additive to the primary dope which passed through the first filtration device. Furthermore, it is more preferable to dispose a second filtration device in the downstream of the inline mixer for filtering the dope, and filter the dope, which is mixed by the inline mixer, through the second filtration device.

It is preferable that the present invention satisfies the following:

(1) 1≦V1/V2≦5, when a velocity of the additive is V1, and a velocity of the primary dope is V2.

(2) An additive ratio of the additive is from 0.1% to 50% in a flow volume ratio.

(3) When a viscosity of the additive is N1 and a viscosity of the primary dope is N2, 1000≦N2/N1≦100000 is satisfied. In addition, at 20° C., 5000 cP≦N2≦500000 cP and 0.1 cP≦N1≦100 cP are satisfied.

(4) A shear rate of the primary dope is from 0.1(1/s) to 30(1/s).

(5) The polymer is cellulose acylate.

(6) The additive is a solution which contains a main solvent of the polymer solution.

(7) The additive is the solution, which contains the main solvent of the polymer solution, and has a different composition from that of the primary dope.

(8) The additive is the solution, which contains the main solvent of the polymer solution, and also contains at least one sort of an ultraviolet absorbing agent.

(9) The additive is the solution, which contains the main solvent of the polymer solution, and formed by dispersing at least one sort of inorganic or organic fine particles.

(10) The additive is the solution, which contains the main solvent of the polymer solution, and also contains at least one sort of a peeling promotion agent.

(11) The additive is the solution, which contains the main solvent of the polymer solution, and also contains at least one sort of a poor solvent.

Further, a film production method of the present invention is characterized in using the dope, which is produced by the above method, and forming a casting film by casting the dope. A protection film for a polarizing filter, or a photographic support used for producing a photographic film can be constituted by using the film production method. Further, the film can be used as an optical compensation film for improving the angle of view of an LCD for a television. In particular, the film is effective in an application in which the optical compensation film also serves as the protection film for the polarizing filter. Therefore, the film is used in IPS mode, OCB mode and VA mode in addition to the conventional TN mode. Further, it is also possible to constitute the polarizing filter by using the protection film for the polarizing filter.

According to the present invention, the primary dope and the additive are stirred and mixed while passing through at least two sorts of inline mixers. As a result, the stirring and mixing is efficiently carried out by effectively utilizing advantages of each type of the inline mixer. Accordingly, the number of the element in the inline mixer can be reduced, and thus downsizing and cost reduction of the manufacturing process can be achieved.

Further, according to the present invention, a uniform dope can be obtained by efficiently stirring and mixing the additive and the primary dope. Therefore, the high-grade product can be obtained by applying the present invention to the film production method using the dope, and production of the protection film for the polarizing filter, the optical compensation film and the photographic support.

### BRIEF DESCRIPTION OF DRAWINGS

FIG. 1 is an explanatory view showing a dope production line;

FIG. 2 is an explanatory view showing a film production line;

FIG. 3 is a perspective view showing a dope channel for an intermittent layer;

FIGS. 4A, 4B and 4C are section views showing the dope channel for the intermittent layer observed from an upper stream; and

FIGS. 5A and 5B are section views showing the dope channel for the intermittent layer observed from a lateral side.

### BEST MODE FOR CARRYING OUT THE INVENTION

[Raw Materials]

In the cellulose acylate to be used in the present invention, a degree of substitution of hydroxyl group preferably satisfies all of the following formulae (1)-(3). (Hereinafter the above cellulose acylate is referred to as TAC):
2.5≦A+B≦3.0 (1)
0A≦3.0 (2)
0≦B≦2.9 (3)

In these formulae, A is the degree of substitution of the hydrogen atom of the hydroxyl group for the acetyl group, and B is a degree of substitution of the hydroxyl group for the acyl group with 3-22 carbon atoms. Preferably, at least 90 wt. % of the TAC particles have a diameter from 0.1 mm to 4 mm.

The cellulose is constructed of glucose units making β-1,4 combination, and each glucose unit has a free hydroxyl group at second, third and sixth positions. Cellulose acylate is a polymer in which part or whole of the hydroxyl groups are esterified so that the hydrogen is substituted by acyl group with two or more carbons. The degree of substitution for the acyl groups in cellulose acylate is a degree of esterification of the hydroxyl group at second, third or sixth position in cellulose. Accordingly, when all (100%) of the hydroxyl group at the same position are substituted, the degree of substitution at this position is 1.

When the degrees of substitution of the acyl groups for the hydroxyl group at the second, third or sixth positions are respectively described as DS2,DS3 and DS6, the total degree of substitution of the acyl groups for the hydroxyl group at the second, third and sixth positions (namely DS2+DS3+DS6) is preferably in the range of 2.00 to 3.00, particularly in the range of 2.22 to 2.90, and especially in the range of 2.40 to 2.88. Further, DS6/(DS2+DS3+DS6) is preferably at least 0.32, and particularly 0.322, and especially in the range of 0.324 to 0.340.

One or more sorts of acyl group may be contained in the cellulose acylate of the present invention. When two or more sorts of the acyl groups are used, it is preferable that one of the sorts is acetyl group. If the total degree of substitution of the acetyl groups for the hydroxyl group and that of acyl groups other than the acetyl group for the hydroxyl group at the second, third or sixth positions are respectively described as DSA and DSB, the value DSA+DSB is preferably in the range of 2.2 to 2.86, and particularly in the range of 2.40 to 2.80. Further, the DSB is preferable to be at least 1.50, and especially at least 1.7. Further, in DSB, the percentage of the substituents for the hydroxyl group at the sixth position is preferably at least 28%, particularly at least 30%, especially at least 31% and most especially at least 32%. Further, the degree of the acyl groups at sixth position is at least 0.75, particularly at least 0.80, and especially preferable to be 0.85. By cellulose acylate satisfying the above conditions, a solution (or dope) having a preferable dissolubility can be prepared. Especially when non-chlorine type organic solvent is used, the adequate dope with a low viscosity and a high filterability can be prepared.

The cellulose acylate can be obtained from cotton linter or cotton pulp. The cellulose acylate obtained from the cotton linter is preferable.

The acyl group having at least 2 carbon atoms may be aliphatic group or aryl group, and is not especially restricted. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferable substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

Solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like.

The preferable solvent compounds are the halogenated hydrocarbons having 1 to 7 carbon atoms, and dichloromethane is especially preferable. In view of physical properties such as a solubility of TAC, a peelability of a casting film from a support, a mechanical strength, optical properties of the film and the like, it is preferable to mix at least one sort of the alcohol having 1 to 5 carbon atoms into the halogenated hydrocarbons. The content of the alcohols is preferably in the range of 2 wt. % to 25 wt. %, and especially in the range of 5 wt. % to 20 wt. % of total solvent compounds in the solvent. As concrete example of the alcohols, there are methanol, ethanol, n-propanol, isopropanol, n-butanol, and the like. It is preferable to use methanol, ethanol, n-butanol or a mixture thereof.

Recently, in order to reduce the influence on the environment, the solvent containing no dichloromethane is proposed. In this case, the solvent contains ethers with 4 to 12 carbon atoms, ketones with 3 to 12 carbon atoms, esters with 3 to 12 carbon atom, or a mixture of them. The ethers, ketones, esthers may have a cyclic structure, and at least one solvent compound having at least two functional groups thereof (—O—, —CO—, —COO—) may be contained in the organic solvent. Note that the organic solvent compound may have other functional group such as alcoholic hydroxy group. When the organic solvent with two or more functional groups is used, the number of carbon atoms is within the predetermined values for each compound of the functional group.

The cellulose acylate is described in detail in paragraphs [0140]-[0195] of the Japanese patent application No. 2004-264464, and the description can be applied to the present invention. Further, details of the solvent of cellulose acylate and additives, such as plasticizers, deteoriation inhibitor, ultraviolet absorbing agent (UV agent), optical anisotropy controlling agent, retardation controlling agent, dye, matting agent, peeling agent and peeling promotion agent, are disclosed in paragraphs [0196] to [0516] of Japanese patent application No. 2004-064464.

[Production of Primary Dope]

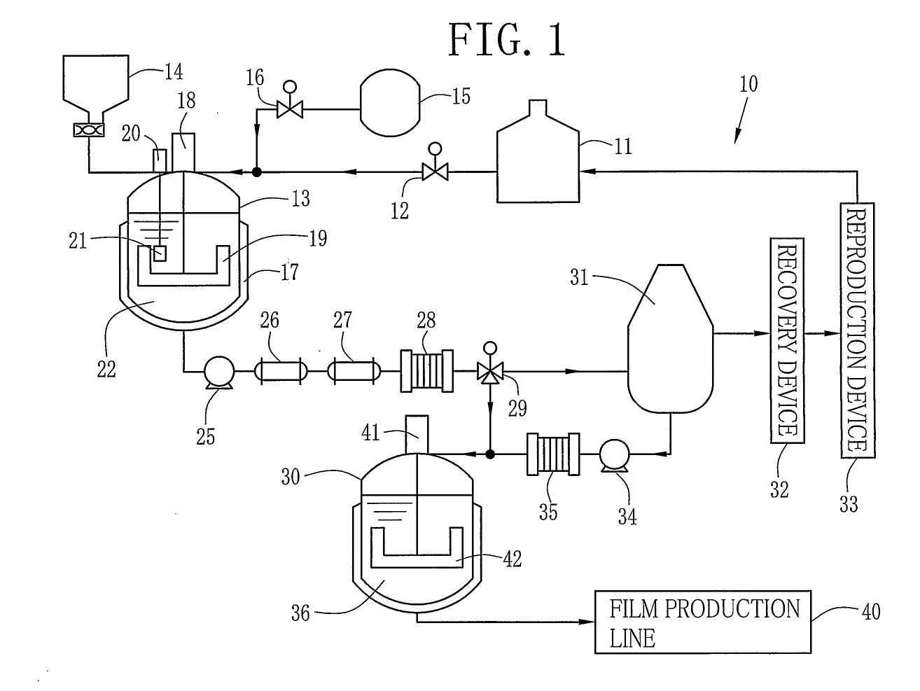

FIG. 1 illustrates a primary dope production line 10. To produce the primary dope, first of all, a valve 12 is opened to feed a solvent from a solvent tank 11 to a dissolution tank 13. Next, TAC in a hopper 14 is fed to the dissolution tank 13 while being measured. A valve 16 is opened and closed to feed a necessary amount of additive solution to the dissolution tank 13. Other than feeding the additive in the form of solution, for instance, when the additive is liquid at room temperature, the additive can be fed to the dissolution tank 13 in the liquid form. Further, when the additive is solid, it is possible to use the hopper 14 to feed the additive to the dissolution tank 13. To add several additives, it is possible to put the solution, in which several additives are dissolved, in the additive tank 15. Also, plural additive tanks, each of which is filled with the solution containing a different additive, can be used. Each solution can be fed to the dissolution tank 13 through a pipe independent from each other.

In the above description, the solvent (including the mixture solvent), the TAC and the additive are put into the dissolution tank 13 in this order; however, the order is not restricted. The preferable amount of the solvent can be fed to the dissolution tank 13 after feeding the TAC to the dissolution tank 13 while measuring the amount of the TAC. Further, it is not necessary to put the additive in the dissolution tank 13 in advance. The additive can be mixed to the mixed compound of the TAC and the solvent later.

A jacket 17 is disposed so as to cover the dissolution tank 13. A first stirrer 19 is attached to the dissolution tank 13 and rotated by a motor 18. Further, it is preferable to attach a second stirrer 21, which is rotated by a motor 20, to the dissolution tank 13. It is preferable that the first stirrer 19 has an anchor blade, and the second stirrer 21 has an eccentric stirrer of a dissolver type. It is preferable to regulate the temperature inside the dissolution tank 13 in a range of −10° C. to 55° C. by passing the heat transfer medium through the jacket 17. A swelling liquid 22, in which the TAC is swelled in the solvent, is obtained by properly selecting and rotating the first stirrer 19 and the second stirrer 21.

The swelling liquid 22 is fed to a heater 26 using a pump 25. It is preferable to use the pipe with the jacket for the heater 26, and is more preferable to have a structure for pressurizing the swelling liquid 22. The primary dope is obtained by dissolving the TAC and the like in the solvent under conditions that the swelling liquid 22 is heated, or pressurized and heated. The temperature of the swelling liquid 22 is preferably from 0° C. to 97° C. Or, a cool-dissolving method, in which the swelling liquid 22 is cooled in a range of −150° C. to −10° C., can also be used. It becomes possible to sufficiently dissolve the TAC in the solvent by properly selecting one of the heat-dissolving method and the cool-dissolving method. After the temperature of the primary dope is adjusted at an approximate temperature by the heater 27, impurities in the primary dope are removed by filtering through a filtration device 28. An average pore diameter of a filter of the filtration device 28 is preferably 100 μm or less. Further, filtration flow rate is preferably at least 50 L/hr. After the filtration, the primary dope is put in the stock tank 30 through a valve 29.

The primary dope can be used as a dope for solution casting which will be described later. However, a method, in which the TAC is dissolved after preparing the swelling liquid 22, requires a longer time as the concentration of the TAC is increased and may result in increasing the cost. In that case, it is preferable to carry out a concentration process in which the primary dope of the intended TAC concentration is prepared after preparation of the primary dope of a lower TAC concentration. The primary dope filtered through the filtration device 28 is fed to a flash unit 31 through the valve 29. In the flash unit 31, a part of the solvent in the primary dope is vaporized. The solvent vapor is condensed to a liquid by a condenser (not shown), and recovered by a recovering device 32. In terms of cost, it is advantageous to reproduce and reuse the recovered solvent as a solvent for preparing the primary dope using a reproduction device 33.

The concentrated primary dope is extracted from the flash unit 31 through a pump 34. Further, it is preferable to remove foam in the primary dope. Any known method, the ultrasonic irradiation method for instance, can be used for removing the foam. Thereafter, impurities are removed through the filtration device 35. At that time, the temperature of the primary dope is preferably from 0° C. to 200° C. Thus, the primary dope 36 is produced with the TAC concentration from 5 wt. % to 40 wt. %. Further, the produced primary dope 36 is stored in the stock tank 30.

Materials, dissolving and adding methods of additives, filtration methods, removal of foam and the like in the dope production method in the solution casting method for obtaining the TAC film are described in detail in paragraphs [0517]-[0616] of the Japanese patent application No. 2004-264464, and the description of this application can be applied to the present invention.

[Solution Casting Method]

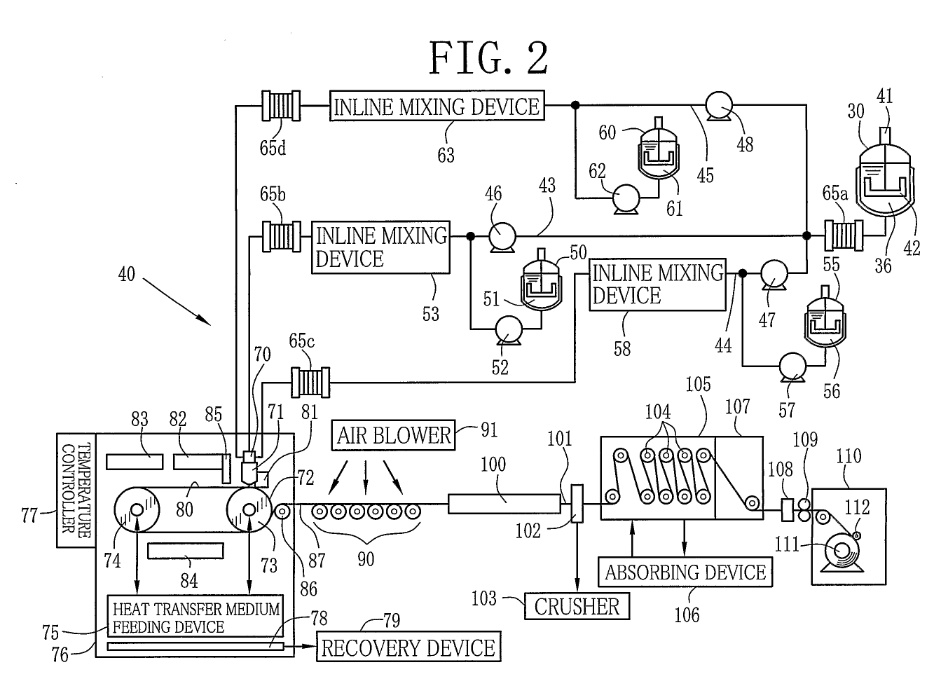

FIG. 2 illustrates a film production line 40. A stirrer 42 is attached to the stock tank 30, which is rotated by a motor 41. The primary dope 36 is constantly kept uniform by rotating the stirrer 42. A dope channel 43 for an intermittent layer, a dope channel 44 for a first surface layer and a dope channel 45 for a second surface layer are connected to the stock tank 30. The primary dope 36 is fed through the pumps 46, 47 and 48 disposed in the dope channels 43, 44 and 45 respectively. The primary dope 36 is then fed to a feed block 70 and merged. Thereafter, the primary dope 36 is cast onto a belt 72 for casting from a casting die 71. Note that the first surface layer is a layer facing the support and the second surface layer is a layer exposed to the air.

[Dope Production Process]

An additive 51 for the intermittent layer in a stock tank 50 is fed and mixed to the primary dope in the dope channel 43 for the intermittent layer (hereinafter referred to as primary dope for the intermittent layer) through a pump 52. Thereafter, an inline mixing device 53 stirs and mixes the additive 51 for the intermittent layer and the primary dope for the intermittent layer so as to be uniform. Thus, the primary dope for the intermittent layer is produced. The additive 51 for the intermittent layer contains the solution (or the dispersed liquid) which previously includes the additives such as the UV-absorbing agent, the retardation controller and the like, for instance.

An additive 56 for the first surface layer in a stock tank 55 is fed and mixed to the primary dope in the dope channel 44 for the first surface layer (hereinafter referred to as the primary dope for the first surface layer) through a pump 57. Thereafter, an inline mixing device 58 stirs and mixes the additive 56 for the first surface layer and the primary dope for the first surface layer so as to be uniform. Thus, the primary dope for the first surface layer is produced. The additive 56 for the first surface layer previously contains additives such as the peeling promotion agent which facilitates peeling from the belt or a support (for instance, citric acid ester), the matting agent for keeping the film surfaces from sticking to each other when the film is wound in a roll form (for instance, silicon dioxide) and the like. Further, the additive 56 for the first surface layer may also contain the additives such as the plasticizer, the UV-absorbing agent and the like.

An additive 61 for the second surface layer in a stock tank 60 is fed and mixed to the primary dope in the dope channel 45 for the second surface layer (hereinafter referred to as the primary dope for the second surface layer) through a pump 62. Thereafter, an inline mixing device 63 stirs and mixes the additive 61 for the second surface layer and the primary dope for the second surface layer so as to be uniform. Thus, the primary dope for the second surface layer is produced. The additive 61 for the second surface layer previously contains additives such as the matting agent for keeping the film surfaces from sticking to each other when the film is wound in a roll form (for instance, silicon dioxide) and the like. Further, the additive 61 for the second surface layer may also contain the additives such as the peeling promotion agent, the plasticizer, the UV-absorbing agent and the like.

Further, in the dope production process, filtration devices 65a, 65b, 65c and 65d are disposed. The filtration device 65a is disposed in the upstream of a branch point which divides the primary dope into dope channels 43, 44 and 45. The filtration devices 65b, 65c and 65d are disposed in the downstream of the inline mixing devices 53, 58 and 63 in the dope channels 43, 44 and 45 respectively. Thus, more uniform dope can be obtained by filtration in the upstream and downstream of the inline mixing devices 53, 58 and 63 respectively.

Further, in the present invention, the primary dope and the various additives are efficiently stirred and mixed by improving the inline mixing devices 53, 58 and 63 in the dope production process. Each dope produced by adding the various additives to each primary dope is fed to the feed block 70 in a predetermined flow rate. After each dope is joined into the feed block, the dope is cast from the casting die 71 onto the belt 72.

[Casting Process]

A 2-phase stainless steel is preferable for the material of the casting die 71. The material had coefficient of thermal expansion of at most 2×10⁻⁵(° C.⁻¹), the almost same anti-corrosion properties as SUS316 in examination of corrosion in electrolyte solution. Further, the material has the anti-corrosion properties which do not form pitting (holes) on the gas-liquid interface after having been dipped in a mixture liquid of dichloromethane, methanol and water for three months. Further, it is preferable to manufacture the casting die 71 by grinding the material which passed more than a month after casting. Using such material, a surface condition of the dope cast on the casting material 71 is kept uniform. It is preferable that the finish precision of a contacting surface of the casting die 71 and the feed block 70 to the dope is at most 1 μm/m, and the straightness is at most 1 μm/m in any direction. Clearance of the slit is automatically controlled in the range from 0.5 mm to 3.5 mm. An end of the contacting portion of each lip to the dope was processed so as to have a chamfered radius at most 50 μm through the slit. Further, it is preferable to adjust the shearing speed in the die 71 in the range of 1(1/sec) to 5000(1/sec).

A width of the casting die 71 is not restricted in size; however, the width of the casting die 71 is preferably in a range between 1.0 time and 2.0 times larger than a width of the film as an end product. Further, it is preferable to install a temperature controller to maintain a predetermined temperature during the production of the film. Further, the casting die 71 is preferably of a coathanger type. Further, it is preferable to provide bolts (heat bolts) at predetermined intervals for adjusting the thickness of the film, and provide an automatic thickness control mechanism using the heat bolts. When using the heat bolts in the film production, it is preferable to set the profile according to the flow rate of the pumps (high-precision gear pumps are preferable) 46-48 based on the previously set program. Further, it is also possible to carry out a feedback control based on an adjustment program according to a profile of a thickness gauge such as an infrared thickness gauge (not shown). A difference in thickness between two arbitrary points is preferably adjusted within 1 μm except for the casting edge portion, and the maximum difference in the minimum values of the thickness in the widthwise direction is 3 μm or less. Further, the thickness accuracy is preferably adjusted at ±1.5 μm.

Further, it is more preferable that lip ends are provided with a hardened layer. In order to provide the hardened layer, there are methods of ceramic coating, hard chrome plating, nitriding treatment and the like. When the ceramics is used as the hardened layer, the ceramic, which is grindable but not friable, with a lower porosity and the good corrosion resistance, is preferred. The ceramic, which sticks to the casting die 71 but does not stick to the dope, is preferable. Concretely, as the ceramics, there are tungsten carbide, Al₂O₃, TiN, Cr₂O₃ and the like, and especially tungsten carbide (WC) is preferable. The hardened layer is formed by a tungsten carbide coating in a spraying method.

The dope, which is discharged to the both edges of a slit of the casting die 71, is partially dried and becomes solid. In order to prevent the solidification of the dope, it is preferable to dispose solvent supplying devices (not shown) at both edges of the slit of the casting die 71. It is preferable to supply a solvent which solubilize the dope (for instance, a mixture solvent of dichloromethane 86.5 pts. mass, acetone 13 pts. mass and n-butanol 0.5 pts. mass.) to bead edges and the air-liquid interface of the slit. It is preferable to use a pump with a pulsation of 5% or less for supplying the dope.

Below the casting die 71, there is a belt 72 wound around the rollers 73 and 74. The belt 72 endlessly move in accordance with a rotation of the rollers 73 and 74 by a driving device (not shown). The moving speed of the belt 72, namely a casting speed is preferably in the range from 10 m/min to 200 m/min. Further, it is preferable that the rollers 73 and 74 are connected to a heat transfer medium feeding device 75 for keeping a surface temperature of the belt 72 at a predetermined value. The surface temperature of the belt 72 is preferably in the range of −20° C. to 40° C. In each roller 73 and 74, there is a heat transfer passage. The temperatures of the rollers 73 and 74 are kept constant at the predetermined value by feeding the heat transfer medium through the heat transfer passage.

A width of the belt 72 is not restricted in size; however, it is preferable that the width of the belt 72 takes a value in a range between 1.1 times and 3.0 times larger than a casting width of the dope. The length of the belt 72 is preferably in the range of 10 mm to 200 mm. The thickness of the belt 72 is preferably in the range of 0.3 mm to 10 mm. It is preferable that the polishing is made such that a surface roughness is at most 0.05 μm. The material of the belt 72 is preferably a stainless steel, and more preferably SUS 316 which offers sufficient corrosion resistance and strength. The thickness unevenness of the belt 72 is at most 0.5%.

A tension to the belt 72 caused by the drive of the rollers 73 and 74 is preferably regulated at 1.5×10⁴ kg/m. Further, the difference of the relative speed of the rollers 73, 74 and the belt 72 is preferably 0.01 m/min or less. The velocity fluctuations of the belt 72 is 0.5% or less. The film meandering in widthwise direction per one rotation is regulated to be 1.5 mm or less. To control the meandering, a detector (not shown) is provided for detecting the positions of both edges of the belt 72. It is preferable to carry out the feedback control according to the detected value. Further, the positional fluctuations in vertical directions of the lips and the belt 72 just below the casting die 71 caused by the rotation of the roller 73 is preferably adjusted to be 200 μm or less.

It is also possible to use the roller 73, 74 as the support. In that case, it is preferable to rotate the rollers 73, 74 with high accuracy so as to keep the rotation unevenness at 0.2% or less. In that case, the average surface roughness of the rollers 73, 74 is preferably 0.01 μm or less. Therefore, the chrome plating is applied to the surface of the rollers 73, 74 to obtain sufficient hardness and resistance. It is necessary to minimize the surface defect of the support (belt 72 and the rollers 73, 74). Concretely, the number of pin holes whose diameter is at least 30 μm is preferably zero. The number of pinholes whose diameter is no smaller than 10 μm and no longer than 30 μm is preferably 1 or less per 1 m². The number of pinholes whose diameter is less than 10 μm is 2 or less per 1 m².

The casting die 71 and the belt 72 are accommodated in a casting chamber 76. A temperature controller 77 is installed to maintain a predetermined temperature in the casting chamber 76. The temperature of the casting chamber 76 is preferably in a range of −10° C. and 57° C. Further, a condenser 78 is disposed to condense organic solvent vapor. The condensed organic solvent is recovered and reproduced by a recovery device 79, and then reused as a solvent for the dope preparation.

The dope (the dope for the first surface layer, the dope for the second surface layer and the dope for the intermittent layer) is co-cast on the belt 72 through the casting die 71 to form a casting film 80 while forming a bead above the belt 72. Note that the temperature of each dope is preferably from −10° C. to 57° C. Further, in order to stabilize the formation of the bead, a decompression chamber 81 is preferably disposed in the upstream in the conveying direction of the belt with respect to the bead, so as to control the pressure at a predetermined value. It is preferable to reduce the pressure of the bead on the decompression chamber side in the range between −10 Pa and −2000 Pa compared to the pressure of the other side of the bead. Further, a jacket (not shown) is preferably attached to the decompression chamber 81 to keep the temperature at a predetermined value. The temperature of the decompression chamber 81 is not especially restricted; however, a range of 10° C. to 50° C. is preferable. Further, a suction device (not shown) is preferably disposed in the side edge portions of the casting die 71 to keep the bead in a desired shape. An edge suction flow rate is preferably in a range of 1 L/min to 100 L/min.

The casting film 80 is conveyed by the belt 72, and at the same time it is preferable to feed drying air from air blowers 82, 83 and 84 to evaporate the organic solvent. The air blowers 82, 83 are disposed in an upstream and a downstream on an upper side of the belt 72 respectively. The air blower 84 is disposed on a lower side of the belt 72 (see FIG. 2). However, the positions of the blowers 82-84 are not restricted in this figure. Further, the surface condition of the film sometimes changes when the drying air is applied onto the casting film 80 just after the formation thereof. In order to reduce the changes in the surface conditions, a wind shielding device 85 is preferably disposed. Although the belt 72 is used as the support in FIG. 2, a drum may also be used as the support. In this case, the surface temperature of the drum is preferably in a range of −20° C. to 40° C.

[Peeling Process and Drying Process]

After obtaining a self-supporting property, the casting film 80 is peeled as a wet film 87 from the belt 72 with support of a peel roller 86. Thereafter, the wet film 87 is transported to a tenter 100 through an interval section 90 with plural rollers. In the interval section 90, a drying air at a predetermined temperature is fed from an air blower 91 to proceed drying of the wet film 87. The temperature of the drying air is preferably in the range of 20° C. to 250° C. Note that in the interval section 90, it is possible to draw the wet film 87 by setting the rotational speed of each roller faster than the adjacent roller in the upstream.

The wet film 87 is transported to a tenter 100 for drying, while both side edges are held by the clips. It is preferable to separate inside the tenter 100 into different temperature zones to adjust the drying conditions. It is also possible to stretch the wet film 87 in the width direction by using the tenter 100. Thus, it is preferable to stretch the wet film 87 in at least one of the casting direction and the width direction in the interval section 90 and/or the tenter 100 in a range between 0.5% to 300%.

An axial misalignment of the slow axis of the birefringence to the widthwise direction of the polymer film of the present invention can be less than 2.0°, further less than 1.0°. The polymer film is preferably stretched and relaxed in the width direction during the solution casting process.

The stretch and relaxation of the wet film 87 is carried out while holding the film with clips. When L1 (mm) is the width of the wet film 87 whose both ends are clipped with clips, L2 (mm) is the maximum width of the wet film 87 when stretched in the width direction and L3 (mm) is a width of the wet film 87 when the wet film 87 is relaxed and the clips are releasing the wet film 87, it is preferable to satisfy the formulae:
1<(L2−L3)/L1×100<15
The drying temperature of the wet film 87 is preferably kept approximately constant during the stretch and relaxation of the wet film 87. The drying temperature of the wet film 87 is preferably kept in the range of 50° C. to 180° C.

It is preferable that the above polymer film is an optical film. The polymer film is preferably cellulose ester film. The cellulose ester film is preferably the cellulose acylate film, more preferably the cellulose acetate film, and most preferably cellulose triacetate film. Further, the present invention includes cellulose ester film used for various optical functional films such as a base film for a photosensitive material, the protective film for the polarizing filter, the base film for the optical compensation film and the like. Further, the present invention includes the LCD which is configured using the optical functional film.

The wet film 87 is dried until the volatile amount reaches a predetermined value through the tenter 100 to be a film 101. Both side edge potions of the film 101 are slit by an edge slitting device 102. The cut edge portions of the film 101 are transported to a crusher 103 by a cutter blower (not shown). The crusher 103 crushes the edge portions of the film 101 into chips. In terms of cost, it is advantageous to reuse the chips for preparing the dope. The step for cutting the both edge portions of the film 101 may be omitted; however, it is preferable to cut the both edge portions of the film in one of the processes between the casting process and the film winding process.

Next, the film 101 is transported into a drying chamber 105 in which plural rollers 104 are disposed. The temperature of the drying chamber 105 is not especially restricted; however, it is preferable to be in the range of 50° C. to 180° C. In the drying chamber 105, the film 101 is conveyed by the rollers 104 in such a way that the film 101 partially wraps around the rollers 104 and the solvent is evaporated. Further the drying chamber 105 is disposed with a recovery device 106. The air, from which the solvent vapor is removed, is fed to the drying chamber 105 as the drying air again. Note that the drying chamber 105 is preferably partitioned into plural partitions so as to vary the drying temperature. Further, it is preferable to provide a pre-drying chamber between the edge slitting device 102 and the drying chamber 105 to pre-dry the film 101. In that way, the deformation of the film 101 caused by the accelerated increase of the film temperature is prevented.

The film 101 is transported into a cooling chamber 107, and cooled to an approximate room temperature. Note that a humidification chamber (not shown) may be provided between the drying chamber 105 and the cooling chamber 107. In the humidification chamber, an air whose moisture and temperature are controlled at desired values is blown on the film 101. Thus curling of the film 101 and the winding defect at the time of winding the film 101 are prevented.

It is preferable to provide a compulsory neutralization device (neutralization bar) 108 such that the charged voltage is kept in the predetermined range (for instance, −3 kV to +3 kV) while transporting the film 101. In FIG. 2, the neutralization device 108 is disposed in a downstream from the cooling chamber 107. However, the position of the neutralization device 108 is not restricted in this figure. Further, it is preferable to provide a knurling roller 109 for providing knurling on the both edge portions of the film 101 with an embossing processing. Note that the height of the projections and the depth of the depressions in the area in which the knurling is provided are preferably in the range from 1 μm to 200 μm.

[Winding Process]

Lastly, the film 101 is wound around a winding shaft 101 in a winding chamber 110. The winding is preferably made with applying a predetermined tension by a press roller 112, and it is preferable to gradually change the tension from a start to an end of the winding. The length of the film 101 to be wound is preferably at least loom in the lengthwise direction (casting direction), and a width thereof is preferably at least 600 mm, and especially preferable in the range of 1400 mm to 1800 mm. However, the present invention is also effective when the width is more than 1800 mm. Further, the present invention can also be applied to the production of the thin film with the thickness in the range of 15 μm to 100 μm.

The solution casting method of the present invention may be a co-casting method, in which a co-casting of two or more sorts of the dopes are made such that the dopes may form a multi-layer film, or a sequentially casting method in which two or more sorts of the dopes are sequentially cast so as to form the multi-layer film. Further, the co-casting method and the sequentially casting method are utilized in combination. When the co-casting is performed, the feed block 70 may be attached to the casting die 71, or a multi-manifold type casting die may be used as shown in FIG. 2. A thickness of each first surface and second surface layer of the multi-layer film on the support is preferably in the range of 0.5% to 30% to the total thickness of the multi-layer film. Furthermore, in the co-casting method, when the dope is cast onto the support, it is preferable that the lower viscosity dopes may entirely cover over the higher viscosity dope. Furthermore, in the co-casing method, when the dope is cast onto the support, it is preferable that the inner dope is covered with dopes whose alcohol contents are higher than the inner dope.

As shown in FIG. 2, the intended properties of the film 101 can be readily obtained by co-casting the three sorts of the dopes. When the film 101 is wound as a roll, it is necessary to prevent the film surfaces from sticking to each other. For that reason, it is preferable to add the matting agent to the dope. However, the matting agent is likely to cause deterioration in the optical properties (for instance, deterioration in transparency and the like). Therefore, as described in the above embodiment, it becomes possible to obtain the desired optical properties and reduce the adhesive property on the surface by adding the matting agent in the dope for the first surface layer and the dope for the second surface layer, and not in the dope for the intermittent layer.

Note that paragraphs from [0617] to [0889] of Japanese Patent Application No. 2004-264464 describe in detail the structure of the casting die, the decompression chamber and the support, co-casting, the peeling, the stretching, the drying condition in each process, a handling method, curling, a winding method after the correction of planarity, a recovering method of the solvent, and a recovering method of film and the like, which may be applied to the present invention.

[Characteristics, Measuring Method]

(Curling Degree and Thickness)

Paragraphs from [0112] to [0139] of the Japanese patent application No. 2004-264464 teach the characteristics and the measuring method of the cellulose acylate film, which may be applied to the present invention.

[Surface Treatment]

It is preferable to make a surface treatment of at least one surface of the cellulose acylate film. Preferably, the surface treatment is at least one of vacuum glow discharge treatment, atmospheric plasma discharge treatment, UV radiation treatment, corona discharge treatment, flame treatment, acid treatment and alkali treatment.

[Functional Layer]

(Antistatic, Hardening Layer, Antireflection, Easy Adhesion and Antiglare)

A primary coating may be made over at least one surface of the cellulose acylate film. Further, it is preferable to use the cellulose acylate film as a base film and provide other functional layers for the cellulose acylate film so as to obtain a functional material. The functional layers may be at least one of an antistatic layer, a cured resin layer, an antireflection layer, an adhesive layer for easy adhesion, an antiglare layer and an optical compensation layer.

Preferably, the functional layer contains at least one sort of surface active agent in the range of 0.1 mg/m² to 1000 mg/m². More preferably, the functional layer contains at least one sort of lubricant in the range of 0.1 mg/m² to 1000 mg/m². Further, preferably, the functional layer contains at least one sort of matting agent in the range of 0.1 mg/m² to 1000 mg/m². Furthermore, preferably, the functional layer contains at least one sort of antistatic agent in the range of 1 mg/m² to 1000 mg/m². Methods for performing a surface treatment on the cellulose acylate film to achieve various functions and characteristics are described in paragraphs [0890] to [1087] of Japanese Patent Application No. 2004-264464 including the conditions and methods in details, which can be applied to the present invention.

[Application]

The cellulose acylate film can be used as the protective film for a polarizing filter. To obtain the LCD, two polarizing filters, in each of which the cellulose acylate film is adhered to a polarizer, are disposed so as to sandwich a liquid crystal layer. Note that the configuration of the liquid crystal layer and the polarizing filters are not restricted in the above example and other known configurations can be used. Japanese Patent application No. 2004-264464 discloses TN type, STN type, VA type, OCB type, reflection type, and other examples of the LCD devices in detail. These types can be applied to the film of the present invention. Further, the application teaches the cellulose acylate film provided with an optical anisotropic layer and that provided with antireflective and antiglare functions. Furthermore, the application discloses to provide the cellulose acylate film with proper optical functions, and thus a biaxial cellulose acylate film is obtained, which is used as the optical compensation film. The optical compensation film also serves as the protective film in the polarizing filter. The description is applied to the present invention. Paragraphs from [1088] to [1265] in application No. 2004-264464 disclose the details.

Further, the production method of the present invention enables to obtain the cellulose triacetate film (TAC film) with excellent optical properties. The TAC film can be used as the protective film in the polarizing filter and the base film for the photosensitive material. Further, the TAC film can be used as an optical compensation film for widening a view angle of the LCD used for the television and the like. In particular, the TAC film is effective in the application where the TAC film serves as the optical compensation film and as the protective film of the polarizing filter. Accordingly, the TAC film can be used for an IPS mode, an OCB mode, a VA mode and the like as well as for a conventional TN mode. Further, it is also possible to form the polarizing filter using the protective film in the polarizing filter.

The following describes the inline mixing devices 53, 58 and 63 in detail. Note that in the present embodiment, the inline mixing devices 53, 58 and 63 have the same structure although different additives are added to each of the inline mixing devices 53, 58 and 63. In the following, the inline mixing device 53 is described as a typical example of the inline mixing devices 53, 58 and 63.

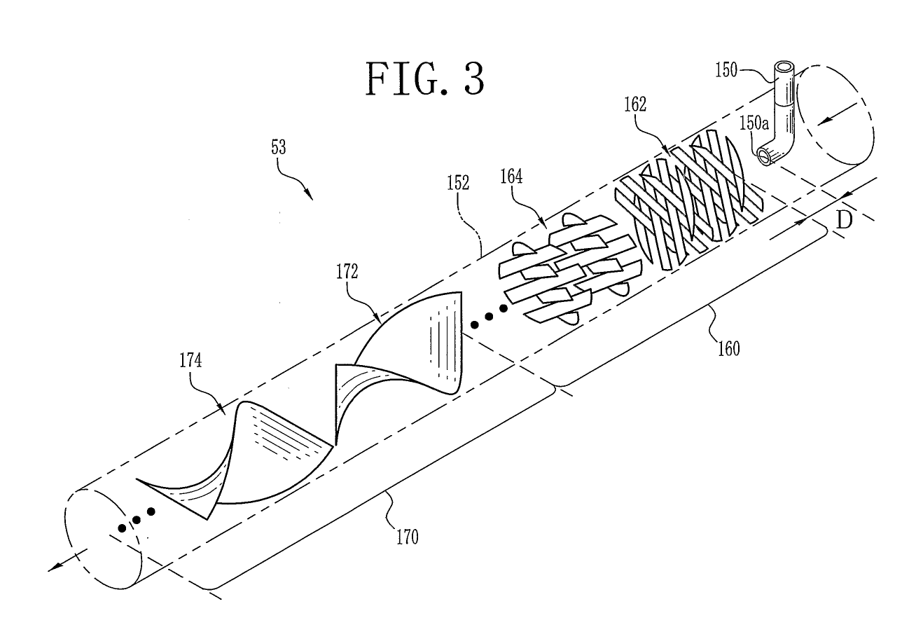

As shown in FIG. 3, in the dope channel 43 for the intermittent layer, an additive supply pipe 150, to which the additive 51 for the intermittent layer is supplied, and the inline mixing device 53 are disposed. The additive supply pipe 150 is disposed through the dope pipe 152, and a tip of the additive supply pipe forms an orifice 150a. The additive supply pipe 150 is constructed so as to place the orifice 150a at the center of a dope pipe 152. The additive 51 for the intermittent layer is fed to the stock tank 50 through the pump 52, and then fed to the dope pipe 152 through the orifice 150a.

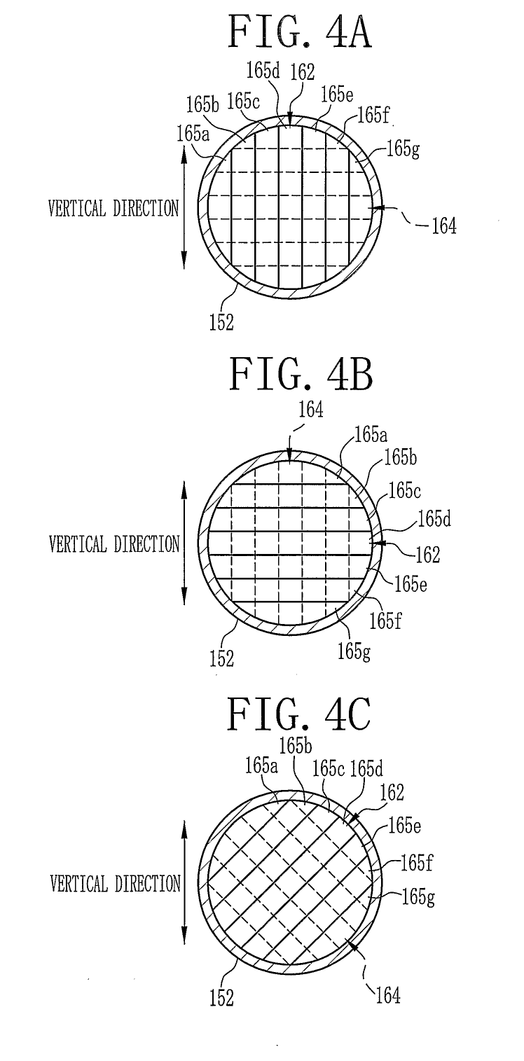

The inline mixing device 53 comprises a sulzer mixer 160, which is a first inline mixer, and a static mixer 170 which is a second inline mixer. The sulzer mixer 160 and the static mixer 170 are connected in series in a lengthwise direction and disposed in a downstream from the additive supply pipe 150. The sulzer mixer 160 is placed next to the orifice 150a. The sulzer mixer 160 has elements 162 and 164 which are alternately placed in the lengthwise direction of the dope pipe 152. The elements 162 and 164 are formed with plural thin partition plates which are intersecting. Further, the elements 162 and 164 are inclined 90 degrees with respect to an axis of the dope pipe 152 and disposed in such a way that the lengthwise directions of the partition plates become orthogonal when the dope pipe 152 is viewed from the upstream (see FIG. 4C). The primary dope and the additive fed to the dope pipe 152 are divided and mixed by the elements 162 and 164 of the sulzer mixer 160 while passing through the dope pipe 152.

The static mixer 170 is disposed in a downstream from the sulzer mixer 160. The static mixer 170 has elements 172 and 174 which are alternately disposed in the lengthwise direction of the dope pipe 152. The elements 172 and 174 are formed by twisting rectangular plates in 180 degrees in opposite directions. The elements 172 and 174 are inclined 90 degrees with respect to the axis of the dope pipe 152 and disposed in such a way that that side edge portions of the elements 172 and 174 become orthogonal. The primary dope and the additive fed to the dope pipe 152 are reversed and mixed by the elements 172 and 174 of the static mixer 170 while passing through the dope pipe 152.

To simplify the explanation, an example in FIG. 3 shows that each of the sulzer mixer 160 and the static mixer 170 is constructed of two elements; however, more number of elements are aligned in actual mixers. The number of elements can be properly changed; however, the number of elements in the static mixer 170 is preferably in a range from 6 to 90, more preferably in a range from 6 to 60.

In the present embodiment, the sulzer mixer 160 is disposed in the upstream and the static mixer 170 is disposed in the downstream. Therefore, the additive fed through the orifice 150a initially passes through the sulzer mixer 160 disposed in the upstream. The sulzer mixer 160 is superior in a dividing effect that the additive is uniformly dispersed throughout the dope pipe 152. Thereafter, the additive passes through the static mixer 170. The static mixer 170 is superior in a reversal effect that the additive is further stirred and kneaded into the primary dope.

It is also possible to dispose the static mixer 170 in the upstream and the sulzer mixer 160 in the downstream. However, in that case, the reversal effect of the static mixer 170 cannot be fully achieved, since the additive is dispersed after being added into a center portion of the primary dope in the dope pipe 152. The inline mixing device 53 improves the efficiency of stirring and mixing by disposing the sulzer mixer 160 in the upstream and the static mixer 170 in the downstream, which make full use of the advantages of the two different types of the mixers.

As described above, the efficiency of the stirring and mixing can be improved by disposing the sulzer mixer 160 in the upstream. However, in case the lengthwise direction of the partition plates 165a-165g, which construct the element 162, is parallel or vertical to the vertical direction of the dope pipe 152 when viewed from the upstream of the dope pipe 152 as shown in FIGS. 4A and 4B for instance, an experiment proved that the dope is divided into an upper and a lower flows. The additive is carried on the divided flows and cannot be fed to the center portion of the sulzer mixer 160. Therefore, in the present embodiment, as shown in FIG. 4C, the partition plates 165a-165g are inclined 45 degrees with respect to the vertical direction of the dope pipe 152. Thus, the additive is fed through the center portion of the element 162, and the primary dope and the additive are efficiently mixed.

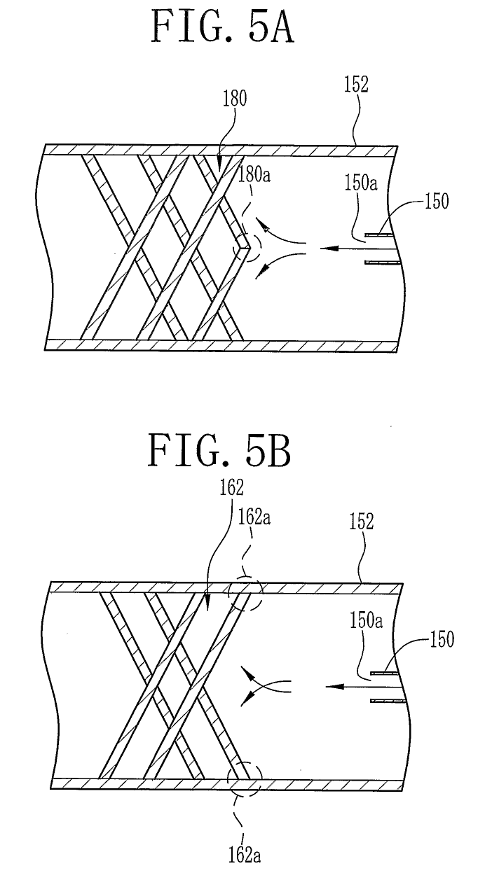

Further, in the present embodiment, the edge portions of the element 162 in the upstream are positioned close to inner walls of the dope pipe 152. For instance, like an element 180 shown in FIG. 5A, when an edge portion 180a is positioned in the center portion of the dope pipe 152 and the element 180 in the upstream has a convex shape, the edge portion 180a divides the primary dope and generates a flow which flows from the center portion toward the inner walls of the dope pipe 152. Then the additive is carried on the flow and concentrated around the inner walls of the dope pipe 152. As a result, sufficient mixing cannot be achieved. On the contrary, the element 162 of the present embodiment shown in FIG. 5B has an edge portion 162a close to the inner wall of the dope pipe 152, and a center portion of the element 162 in the upstream has a concave shape. As a result, the additive is gathered into the center portion of the dope pipe 152 and uniformly dispersed from the center portion throughout the dope pipe 152. Thus, the sufficient mixing is achieved.

To increase the efficiency of the stirring and mixing, a distance D between the inline mixing device 53 and an orifice 150a is preferably in a range of 1 mm to 150 mm, more preferably in a range of 1 mm to 15 mm. When the distance D is too close, the orifice 150a may be plugged due to resistance of the primary dope. On the contrary, when the distance D is too far, the additive may not be fed to the center portion of the inline mixing device 53.

Further, an additive ratio is preferably in a range of 0.1% to 50% in a flow volume ratio. When the additive ratio is too low, it is difficult to accurately add the additive. When the additive ratio is too high, it becomes difficult to mix the additive and the primary dope.

Further, when V1 is a velocity of the additive and V2 is a velocity of the primary dope, it is preferable to satisfy 1≦V1/V2≦5, more preferable to satisfy 1≦V1/V2≦3. When V1/V2 is too small, the additive may not be continuously fed in a feeding direction. When the V1/V2 is too large, the additive may increase the momentum and passes through the inline mixing device 53 without being mixed.

Further, when N1 is a viscosity of the additive, when N2 is a viscosity of the primary dope, N1 is preferably in a range of 0.1 cP to 100 cP, N2 is preferably in a range of 5000 cP to 500000 CP and the viscosity ratio is preferable to satisfy 1000≦N2/N1≦1000000 at 20° C.

Further, a shear rate V3 of the primary dope flowing in the dope pipe 160 is preferably in a range of 0.1(1/s) to 30(1/s). When the shear rate V3 is too small, the mixing may not be proceeded. On the contrary, when the shear rate V3 is too large, the pressure drop of the dope pipe 152 is increased, which 20 kg pressure resistance may not withstand. Thus the inline mixing devices 53, 58 and 63 efficiently carry out the stirring and mixing while taking advantages of two different types of the mixers: the sulzer mixer 160, which is superior in the dividing effect, and the static mixer 170 which is superior in the reversal effect. Accordingly, the number of the elements is reduced, which enables the downsizing of the process and cost reduction.

Note that in the present invention, the primary dope and the additive are stirred and mixed using two or more sorts of the inline mixing devices. Therefore, forms of the inline mixing devices are not limited to the above embodiment, and can be properly changed. For instance, an example is explained in the above embodiment, in which the static mixer is disposed in the downstream from the sulzer mixer; however, another sulzer mixer may be disposed in the downstream from the static mixer. Besides the sulzer mixer and the static mixer used in the above embodiment, a dynamic mixer may be disposed, which uses a power such as a motor to rotate the stirring blades disposed in the dope pipe. Further, to make the dope more uniform, the filtration device can be disposed in one or both sides of the upstream and downstream from the inline mixing device.

### Embodiment 1

A concrete embodiment 1 of the present invention is explained. In the embodiment 1, the dope is produced by using the inline mixing devices 53, 58 and 63 explained in the above embodiment in a dope production process which will be described later. Then a film is produced by casting the dope. Concrete conditions of the film production are described in the following; however, the present invention is not limited in the embodiment 1.

Each pts. mass of content used in the embodiment 1 is as follows.

[Composition]

| | | |
|---|---|---|
| Cellulose triacetate | 100 | pts. mass |
| (fine particles whose degree of substitution is 2.84, | | |
| viscometric average degree of polymerization is 306, | | |
| moisture content is 0.2 mass %, viscosity of 6 mass % | | |
| of dichloromethane solution is 315 mPa · s, average | | |
| particle diameter is 1.5 mm and average variation of | | |
| the particle diameter is 0.5 mm.) | | |
| Dichloromethane (first solvent) | 320 | pts. mass |
| Methanol (second solvent) | 83 | pts. mass |
| 1-Butanol (third solvent) | 3 | pts. mass |
| Plasticizer A (Triphenylphosphate) | 7.6 | pts. mass |
| Plasticizer B (diphenylphosphate) | 3.8 | pts. mass |

[Cotton Compounds]

The cellulose triacetate used in this embodiment contains the following: remaining amount of acetic acid was 0.1 mass % or less, Ca content was 58 ppm, Mg content was 42 ppm, Fe content was 0.5 ppm, free acetic acid was 40 ppm and sulphate ion was 15 ppm. Further, substitution of the acetyl group at the sixth position was 0.91, and was 32.5% of the acetyl group. Further, extraction of acetone was 8 mass %. A ratio of weight average molecular weight/number average molecular weight was 2.5. Further, yellow index was 1.7. Haze was 0.08. Transparency was 93.5%. Tg (glass transition temperature measured by DSC) was 160° C. The heating value of crystallization was 6.4 J/g. The cellulose triacetate was chemically synthesized from cellulose extracted from cotton.

(1) Preparation of Primary Dope

The dope production line 10 shown in FIG. 1 is used. The cellulose triacetate powder (flake) is gradually dispensed from the hopper 14 into the 4000 L stainless steel dissolution tank 13, in which the plural solvents are stirred and dispersed as mixture solvents, to prepare 2000 kg of the primary dope as a whole. The stirrers 19 and 21 are disposed in the dissolution tank 13. Further, the moisture content of all solvents was 0.5 wt. % or less. The dissolution tank 13 has a first stirrer 19, which has the anchor blade on the shaft and a second stirrer 21, which has the eccentric stirring shaft of the dissolver type. The cellulose acylate powder and the solvent are dispersed for 30 minutes on condition that the first stirrer 19 stirs at the peripheral speed of 1 m/sec (shearing stress of 1×10⁴ kgf/m/sec²) and the second stirrer 21 stirs at the peripheral speed of 5 m/sec (shearing stress of 5×10⁴ kgf/m/sec²). Temperature at the start of the dispersion was 25° C. and finally reached 48° C. After dispersion, high-speed stirring is stopped. Still, stirring by the first stirrer 19 is continued for 100 minutes at the peripheral speed of 0.5 m/sec. Thereby, the cellulose triacetate flake was swelled and the swelling liquid 22 was obtained. The pressure was applied to the dissolution tank 13 using nitrogen gas to keep the inside of the dissolution tank 13 at 0.12 MPa until the completion of the swelling. An oxygen concentration inside the dissolution tank 13 is less than 2 vol. %, which kept the tank free from explosion. The moisture content in the primary dope is 0.3 mass %.

(2) Dissolution and Filtration

The swelling liquid 22 is fed from the dissolution tank 13 to the heater 26 through a pump 25. The swelling liquid 22 is heated to 50° C. through the heater 26, further heated through the application of a pressure of 2 MPa and completely dissolved. The heating time was 15 minutes. Then the temperature of the swelling liquid 22 is lowered to 36° C. by the temperature controller 27. Thereafter, the swelling liquid 22 is passed through the filtration device 28, which is formed of filtration media with nominal pore diameter of 8 μm, and a primary dope with the solid content concentration of 19 mass % (hereinafter referred to as primary dope before concentration) is obtained. At that time, a primary pressure of the filtration was 1.5 MPa and the secondary pressure of the filtration was 1.2 MPa. Further, the filter, the housing and the pipe which are exposed to high temperature are made of hastelloy alloy to be superior in corrosion resistance, and provided with jackets in which heat transfer medium is circulated for insulation and heating.

(3) Concentration, Filtration and Removing Foam

The primary dope (before concentration) is flashed in the flash unit 31, which is kept at a normal pressure at 80° C., to vaporize the solvent. The solvent vapor is condensed and liquefied by the condenser, and the liquid is recovered and separated by the recovering device 32. The solid content concentration of the primary dope after the flash is 21.8 mass %. Further, the recovered solvent is reproduced in the reproduction device 33 for reusing. An anchor blade is attached to a center axis of a flash tank of the flash device 31, and foam is removed by stirring at a peripheral speed of 0.5 m/sec. A temperature of the primary dope in the flash tank is 25° C. An average residence time of the primary dope in the tank is 50 minutes. The primary dope is extracted and a shear viscosity is 450 Pa·s which is measured at 25° C. at a shear rate of 10(1/s).

Next, foam is removed by irradiating weak ultrasonic waves to the primary dope. Thereafter, the primary dope is fed to the filtration device 35 using the pump 34 while applying pressure of 1.5 MPa to the primary dope. In the filtration device 35, the primary dope is passed through a sintered metal fiber filter with a nominal pore diameter of 10 μm, and then the other sintered metal fiber filter of the same size (a nominal pore diameter of 10 μm). Primary pressures applied to the sintered metal fiber filters are 1.5 MPa and 1.2 MPa respectively. Secondary pressures are 1.0 MPa and 0.8 MPa respectively. The temperature of the primary dope after the filtration is kept at 36° C. and stored in the 2000 L stainless steel stock tank 30. The stock tank 30 has the anchor blade 42 on the center axis, and the primary dope is constantly stirred at the periphery speed of 0.3 m/sec. Note that during preparation of the primary dope from the dope before concentration, corrosion and the like did not occur in a contact portion of each device contacting the dope. The mixture solvent 37 is prepared, which contains 86.5 pts. mass of dichloromethane, 13 pts. mass of acetone and 0.5 pts. mass of n-butanol.

(4) Discharge

A film is produced using the film production line 40 as shown in FIG. 2. Next, the primary dope 36 in the stock tank 30 is fed through high accuracy gear pumps 46, 47 and 48 for boosting the primary pressure while carrying out a feedback control by an inverter motor so as to keep the primary pressure of the pumps 46-48 at 0.8 MPa. As the performance capabilities of the high accuracy gear pump 46-48, the volume efficiency is 99.2%, and the fluctuation ratio of discharge amount is 0.5% or less. The discharge pressure is 1.5 MPa.

The casting die 71 is 1.8 m in width, and equipped with the feed block 70, which is adjusted for co-casting, so as to form a film with three layers, sandwiching a main layer with two layers. In the following description, a main layer is referred to as the intermittent layer, a layer facing the support is referred to as the first surface layer, and a layer on the opposite side of the first surface layer is referred to as the second surface layer. Further, there are three dope channels: the dope channel 43 for the intermittent layer, the dope channel 44 for the first surface layer and the dope channel 45 for the second surface layer.

(5) Production of Dope

An additive 51 for the intermittent layer, in which a UV agent a (2-(2′-hydroxy-3′,5′-di-tert-butylphenyl)benzotriazol), a UV agent b (2-(2′-hydroxy-3′,5′-di-tert-amylphenyl)-5-chlorobenzotriazol), a retardation control agent (N,N′-di-m-tolyl-N″-P-methoxyphenyl-1,3,5-triazine-2,4,6-triamine), the mixture solvent 37 and the primary dope 36 are mixed, is put in the stock tank 50. The additive 51 for the intermittent layer is fed to the primary dope 36 in the dope channel 43 of the intermittent layer through the pump 52. Then, the additive 51 and the primary dope 36 are mixed using the inline mixing device 53 and thus the dope for the intermittent layer is produced. The mixture is prepared such that the total solid concentration is 21.8 mass %, the UV agents a and b are 1.2 mass % in the film form respectively, and the retardation control agent is 2.6 mass % in the film form.

The additive 56 for the first surface layer is formed by dissolving or dispersing 0.05 pts. mass of silicon dioxide (particle diameter: 15 nm, Mohs' hardness: approximately 7), which is a matting agent, 0.006 pts. mass of citric acid ester mixture(citric acid, citric acid monoethyl ester, citric acid diethyl ester and citric acid triethyl ester), which is a peeling promotion agent, the primary dope 36 and the mixture solvent 37. The additive 56 for the first surface layer is put in the stock tank 55 and fed to the primary dope 36 passing through the dope channel 44 for the first surface layer through the pump 57 with a desired flow rate. Then, the additive 56 for the first surface layer and the primary dope 36 are mixed using the inline mixing device 58 and thus the dope for the first surface layer is produced. The additive is added such that the total solid content concentration is 20.5 mass %, the concentration of the matting agent is 0.05 mass % in the film form and the concentration of the peeling promotion agent is 0.03 mass % in the film form.

The additive 61 for the second surface layer is prepared by dispersing silicon dioxide in the mixture solvent 37 and put in the stock tank 60. The additive 61 for the second surface layer is fed to the primary dope 36 in the dope channel 45 for the second surface layer through the pump 62. Then, the additive 61 for the second surface layer and the primary dope 36 are mixed using the inline mixing device 63 and thus the dope for the second surface layer is produced. The additive is added such that the total solid content concentration is 20.5 mass % and the concentration of the matting agent is 0.1 mass % in the film form.

(6) Casting

Casting is carried out by adjusting the flow rate of each dope (the dope for the intermittent layer, the dope for the first surface layer and the dope for the second surface layer) so as to form each layer thickness 4 μm, 73 μm and 3 μm that the total thickness of the product is 80 μm, while setting the casting width as 1700 mm. To regulate the temperature of each dope at 36° C., the jacket (not shown) is disposed on the casting die 71 and an inlet temperature of the heat transfer medium supplied in the jacket is set at 36° C.

The casting die 71, the feed block 70 and the pipe are insulated at 36° C. The casting die 71 is of a coathanger type. Further, the casting die 71 is provided with bolts (heat bolts) at 20 mm pitch for adjusting the thickness of the film, and equipped with the automatic thickness control mechanism using the heat bolts. The heat bolts enable to set the profile according to the flow rate of the high-precision gear pumps 46-48 based on the previously set program and to carry out the feedback control based on the adjustment program according to the profile of the thickness gauge such as the infrared thickness gauge (not shown) disposed on the film production line 40. A difference in thickness between two points, which are 50 mm apart, is preferably adjusted within 1 μm except for the casting edge portion (20 mm), and the maximum difference in the minimum values of the thickness in the widthwise direction is 3 μm or less. Further, the average thickness accuracy of the first and second surface layers is adjusted to be ±2% or less, that of the main layer is adjusted to be ±1% or less, and that of the whole thickness is adjusted to be ±1.5 μm or less.

In the upstream of the casting die 71 with respect to the conveying direction, a decompression chamber 81 was disposed, whose decompression rate can be adjustable depending on the casting speed, such that there would be a pressure difference in the range of 1 Pa to 5000 Pa between up- and downstream sides of the casting bead. Further, the decompression chamber 81 is also equipped with a mechanism which enables to set the temperature higher than the condensing temperature of the gas around the casting section. There was labyrinth packing (not shown) in front and rear sides of the bead. Further, there were openings in both sides. Further, in order to compensate the disorder of the both side edges of the casting beads, an edge suctioning device (not shown) was used.

The material of the casting die 71 is the 2-phase stainless steel. The material had coefficient of -thermal expansion of at most 2×10⁻⁵(° C.⁻¹), the almost same anti-corrosion properties as SUS316 in examination of corrosion in electrolyte solution. Further, the material has the anti-corrosion properties which do not form pitting (holes) on the gas-liquid interface after having been dipped in a mixture liquid of dichloromethane, methanol and water for three months. It is preferable that the finish precision of a contacting surface of the casting die 71 and the feed block 70 to the dope is at most 1 μm/m, and the straightness is at most 1 μm/m in any direction. The clearance of the slit is automatically controlled at 1.5 mm. The end of the contacting portion of each lip to the dope was processed so as to have the chamfered radius at most 50 μm through the slit. Further, it is preferable to adjust the shearing speed in the die 71 in the range of 1(1/sec) to 5000(1/sec). The lip ends of the casting die 71 are provided with the hardened layer formed by the tungsten carbide (WC) coating in the spraying method.

The dope, which is discharged to the both edges of the slit of the casting die 71, is partially dried and becomes solid. In order to prevent the solidification of the dope, the solvent, which solubilize the dope, is supplied to the bead edges and the air-liquid interface of the slit at 0.5 ml/min on each side. It is preferable to use the pump with a pulsation of 5% or less for supplying the dope. Further, the decompression chamber 81 decreases the pressure in the rear portion of the bead by 150 Pa. To keep the temperature of the decompression chamber 81 constant, the jacket (not shown) is disposed. The heat transfer medium, which is regulated at 35° C., is supplied through the jacket. The edge suction flow rate is adjustable in a range of 1 L/min to 100 L/min. In this embodiment, the edge suction flow rate is properly adjusted in the range of 30 L/min to 40 L/min.

An endless belt made of stainless steel, which is 2.1 m in width and 70 m in length, is utilized as the belt 72 for casting. The thickness of the belt 72 is preferably 1.5 mm. The polishing is made such that a surface roughness is 0.05 μm or less. The material of the belt 72 is SUS 316 which offers sufficient corrosion resistance and strength. The thickness unevenness of the belt 72 is at 0.5% or less. The belt 72 is driven by two rollers 73, 74. At that time, a tension to the belt 72 caused by the drive of the rollers 73 and 74 is regulated at 1.5×10⁴ kg/m. The difference of the relative speed of the rollers 73, 74 and the belt 72 is preferably 0.01 m/min or less. The velocity fluctuation of the belt 72 is 0.5% or less. The film meandering in widthwise direction per one rotation is regulated to be 1.5 mm or less by detecting the positions of both edges of the belt 72. The positional fluctuations in vertical directions of the lips and the belt 72 just below the casting die 71 is preferably adjusted to be 200 μm or less. The belt 72 is disposed in the casting chamber 76 with a control means (not shown) for controlling wind loading fluctuations. The three layers of dopes (the first surface layer, the intermittent layer, the second surface layer) are co-cast from the casting die 71 to the belt 72.

Into the rollers 73, 74 are fed the heat transfer medium so as to perform the temperature regulation of the belt 72. Into the roller 73 in a side of the casting die 71 was fed the heat transfer medium (water) at 5° C. and into the roller 74 was fed the heat transfer medium (water) at 40° C. The surface temperature of the middle portion of the belt 72 just before the casting was 15° C., and the temperature difference between both side edges was at 6° C. or less. Note that the surface of the belt 72 is preferably defect-free. Concretely, the number of pin holes whose diameter is at least 30 μm is preferably zero. The number of pinholes whose diameter is from 10 μm to 30 μm is preferably 1 or less per 1 m². The number of pinholes whose diameter is less than 10 μm is 2 or less per 1 m².

The temperature of the casting chamber 76 was kept to 35° C. by the temperature controller 77. The dope was cast onto the belt 72 to form the casting film 80, to which the drying air of parallel flow to the casting film 80 was fed at first to dry. Overall heat transfer coefficient from the drying air to the casting film 80 at the time of drying was 24 kcal/m²·hr·° C. The temperatures of the drying air from the air blowers 82 and 83 in the upstream and the downstream of the belt 72 was 135° C. and 140° C. respectively. Further, the drying air is fed from the air blower 84 to the lower side of the belt 72 at 65° C. The saturated temperature of each drying air was about −8° C. The oxygen concentration is kept at 5 vol % in drying atmosphere on the belt 72. Further, the nitrogen gas substitutes for the air to keep the oxygen concentration at 5 vol %. Furthermore, the condenser 78 is provided for condensing and recovering the solvent in the casting chamber 76. The outlet temperature of the condenser 78 is set at −10° C.

(7) Peeling and Drying

For five seconds after the casting, a wind shielding device 85 restricts fluctuations in static pressure in the immediate area of the casting die 71 at ±1 Pa or less by shielding the dope and the casting film 80 from the drying air. The casting film 80 is peeled from the belt 72 as a film (hereinafter referred to as the wet film) 87 while supported by a peel roller when the solvent ratio in the casting film 80 is 150 mass % (dry measure). At that time, peeling tension is 10 kgf/m. To reduce the peeling failure, the peel speed (draw of the peel roller) is properly adjusted in a range of 100.1% to 110% with respect to a speed of the belt 72. The surface temperature of the wet film 87 is 15° C. The average drying speed on the belt 72 is 60 mass % (dry measure)/min. Solvent gas generated in the drying process is condensed and liquefied in the condenser 78 at −10° C., and recovered by the recovering device 79. The recovered solvent is reproduced and reused as the solvent for the dope preparation. At that time, the moisture content in the solvent is controlled to 0.5% or less. The drying air, from which the solvent is removed, is heated again and reused as the drying air. The wet film 87 is transported through the rollers of the interval section 90 and sent to the tenter 100. At that time, the drying air at 40° C. is supplied from the air blower 91 to the wet film 87. Further, a tension of approximately 20N is applied to the wet film 87 while feeding the wet film 87 by the rollers of the interval section 90.

The wet film 87 is then transported to the tenter 100. The wet film 87 is fed through a drying zone in the tenter 100, while both side edges are held by the clips, and dried in the drying air. The heat transfer medium at 20° C. is supplied to the clips for cooling. The tenter 100 is driven by chains, and the rate of fluctuation in the sprocket is 0.5% or less. Further, the tenter 100 is separated into three zones, and a temperature of the drying air in each zone is 90° C., 100° C. and 110° C. from the upstream. The gas composition of the drying air is that of saturated gas concentration at −10° C. The average drying speed in the tenter 100 is 120 mass % (dry measure)/min. Conditions of the drying zone is adjusted in such a way that remaining solvent in the film is 7 mass % at the outlet of the tenter 100. Further, in the tenter 100, the wet film 87 is stretched in the widthwise direction while being fed. A widening ratio is 103% with respect to the width (100%) of the wet film 87 when transported to the tenter 100. Stretch rate (the tenter drive draw) from the peel roller 86 to the tenter 100 is 102%. A difference in the stretch rates between a holding portion and a portion 10 mm away from the holding portion is 10% or less, and a difference in the stretch rates between arbitrary two points, which are 20 mm away from each other, is 5% or less. 90% of the length of the base edge portion is fixed at the tenter 100. The solvent vapor in the-tenter 100 is condensed and liquefied at −10° C. and recovered. The condenser (not shown) is disposed for condensing and recovering, and the outlet temperature of the condenser is set at −8° C. The recovered solvent is reused after adjusting the moisture content to be 0.5 wt. % or less. Thereafter, the wet film 87 is transported out of the tenter 100 as the film 101.

The both edge portions of the film 101 are cut by the edge slitting device 102 within 30 seconds after the film 101 passes through the outlet of the tenter 100. Both edge portions of the film are cut using a NT type cutter at 50 mm from each side end. The cut edge portions are transported to the crusher 103 by a cutter blower (not shown). The crusher 103 crushes the edge portions into chips with an average size of 80 mm². The chips are used again as the material for the dope production along with TAC flakes. An oxygen concentration of the tenter 100 is kept at 5 vol % in an atmosphere of dry air. Further, air is substituted by nitrogen gas to keep the oxygen concentration at 5 vol %.

Before drying the film 101 at a high temperature in a drying chamber 105, which will be described later, the film 101 is preheated in a preheating chamber (not shown) which supplies the drying air of 100° C.

The film 101 was dried at a high temperature in the drying chamber 105. The drying chamber 65 is partitioned into 4 sections, and the hot air is supplied from the air blower (not shown) to each section from the upstream at 120° C., 130° C., 130° C. and 130° C. The tension of transporting the film 101 by the roller 104 in the drying chamber was 100 N/width, and the drying was made for about 10 minutes such that the content of the remaining solvent might be less than 0.3 mass %. Lap angles of the roller 104 are 90 degrees and 180 degrees (the lap angles are exaggerated in FIG. 2). The material of the roller 104 was aluminum or carbon steel, and a hard chrome coating was made on a surface. Two types of the rollers 104 were used. In the first type, the surface of the roller 104 was flat, and in the second type, the blasting was made for the matting process on the surface. The positional fluctuations (or eccentricity) in the rotation of the roller 104 was 50 μm or less, and the bending of the roller 104 at the tension of 100 N/width was 0.5 mm or less.

The solvent gas contained in the drying air was removed by the recovering device 106 of an adsorption type. The adsorptive agent was activated carbon, and the desorption was made with the dried nitrogen. Thus the moisture content of the recovered solvent was made 0.3 mass % or less, and thereafter the recovered solvent was used for the solvent for preparing the dope. The drying air includes not only the solvent gas but also other compounds such as the plasticizer, the UV-absorbing agent and the compounds of high boiling points. Therefore such compounds are removed by cooling of cooling device and a preadsorber, and recycled. Then the adsorption and desorption conditions were set such that VOC (volatile organic compounds) in the exhaust gas might become at 10 ppm or less. Further, the solvent amount recovered by the condensing method is 90 mass %, and most of the remainder is recovered by adsorption.

The dried film 101 is transported to a first humidification chamber (not shown). The drying air at 110° C. is supplied to an interval section between the drying chamber 105 and the first humidification chamber. The air at 50° C., with the dew point of 20° C., is supplied to the first humidification chamber. Further, the film is transported to a second humidification chamber (not shown) which restricts occurrence of curling in the film 101. In the second humidification chamber, the air at 90° C. with the humidity of 70% is directly supplied to the film 101.

After humidification, the film 101 is cooled to 30° C. or below in a cooling chamber 107, and then both edge portions of the film 101 were trimmed. The compulsory neutralization device (the neutralization bar) 108 is provided such that the charged voltage is constantly kept from −3 kV to +3 kV while transporting the film 101. Further, knurling is provided on the both side edge portions of the film 101 by the knurling roller 109. Knurling is performed by embossing one side of the film 101. The width of knurling is 10 mm, and the pressure is set such that the maximum height is 12 μm higher in average than the average thickness.

(8) Winding

Thereafter, the film 101 is transported into a winding chamber 110 in which the temperature was 28° C. and the humidity was 70%. Further, an ionizer (not shown) is disposed in the winding chamber 110 such that the charged voltage might be in the range of −1.5 kV to +1.5 kV. Thus the film 101 (thickness of 80 μm) is obtained to have the width of 1475 mm. 0The diameter of the winding shaft 111 was 169 mm. The tension was 360 N/width in the beginning of winding and 250 N/width in the end of winding. The total length of the wound-up film was 3940 m. The length of the film to be wound around the winding shaft was 400 m, and the oscillation range was ±5 mm. Further, a press roller 112 is pressed toward the winding roller 111 at 50 N/width. In the winding, the temperature of the film was 25° C., and the moisture content was 1.4 mass %, the content of the remaining solvent was 0.3 mass %. Average drying speed throughout the process was 20 mass % (dry measure)/min. Further, no winding looseness and wrinkles were found. Unevenness in winding did not occur in an impact test at 10 G. An appearance of a roll was excellent.

A film roll of the film 101 was stored in a storing rack at 25° C. and 55% RH for a month. A similar test as the above was applied to the film 101; however, no significant differences were found. Further, there was no adherence between the films of the film roll. Further, after the production of the film 101, residues were not found on the belt after peeling off the casting film 80.

(9) Results and Evaluation

An evaluation method of a test sample obtained by the embodiment is described as follows.

(i) Stability of Solution

The primary dope 36 is extracted and statically stored at 30° C., and evaluated in the following four scales, A, B, C and D.
A: transparency and liquid uniformity are still displayed after 20 days.
B: transparency and liquid uniformity are displayed after 10 days. The liquid becomes slightly whitish after 20 days.
C: The liquid is transparent and uniform when the dope preparation is completed. However, gelling appears after one day and the liquid becomes nonuniform.
D: Swelling and dissolution are not displayed. The solution is opaque and nonuniform.

(ii) Film Surface

The film 101 is visually inspected and the surface of the film 101 is evaluated as follows:
A: The film surface is smooth.
B: The film surface is smooth. However, some foreign particles are visible on the film surface.
C: Weak asperities are visible on the film surface, and the presence of the foreign particles is clearly observed.
D: Asperities and many foreign particles are visible on the film surface.

(iii) Humidity and Heat Resistance of the Film

1 g is cut from the film 101 as a test sample. The cut test sample is folded and put into a glass bottle of 15 ml. The glass bottle is sealed after carrying out the humidification at 90° C. and 100% RH. The test sample is taken out of the glass bottle after ten days while keeping the temperature at 90° C. The condition of the film is visually inspected. The evaluation is carried out as follows.
A: No abnormalities are found.
B: Slight decomposition odor is detected.
C: Significant decomposition odor is detected.
D: Decomposition odor and changes in the shape caused by decomposition are detected.

The stability of the primary dope 36 was A. Further, the film 101 was excellent in all the following items: the film surface was A, the result of the film tearing test was 16 g, the result of the folding endurance test was 71 times and the moisture and heat proof was A. Further, remaining amount of acetic acid was 0.01 wt. % or less. Ca content was 0.05 wt. % or less. Mg content was 0.01 wt. % or less. The thickness of the film 101 was 80 μm±1.5 μm. At that time, both edge portions and the center portion of each of front, intermittent and rear section in the lengthwise direction of the film 101 are evaluated. An error of the result was 0.2% or less. Further, average heat shrinkage in vertical and horizontal directions was −0.1% (at 80° C. and 90% RH for 48 hours). Thus, the film 101, which is resistant to the heat shrinkage, is obtained. Further, the remaining solvent amount was 7 mass % at the outlet of the tenter, and the lower explosion limit of the film edge silo was excellent, which was 25% or less.

Further, the film 101 displayed following properties. The haze was 0.3%. The transparency was 92.4%. Slope width was 19.6 nm. The wavelength limit was 392.7 nm. The absorption edge was 374.1 nm. The absorption of 380 nm was 2.0%. Re (retardation value in the front direction) was 1.2 nm. Rth (retardation value in the film thickness direction) was 48 nm. Molecular orientation axis is 1.4 degrees. Elastic modulus was 3.54 GPa in the lengthwise direction, and 3.45 GPa in the widthwise direction. Tensile strength was 142 MPa in the lengthwise direction, and 141 MPa in the widthwise direction. The stretch rate was 43% in the lengthwise direction and 49% in the widthwise direction. Coefficient of static friction was 0.65 and that of dynamic friction was 0.51. Alkaline hydrolysis was A. The curl value was −0.4 at 25% RH, and was 1.7 when wet. Further, the moisture content was 1.4 mass %. Remaining solvent amount was 0.3 mass %. Heat shrinkage was −0.09% in the lengthwise direction, and −0.08% in the widthwise direction. As the foreign particles, the number of lints is less than 5/m. Further, the number of the luminescence points with the size from 0.02 mm to 0.05 mm was less than 10/3 m and from 0.05 mm to 0.1 mm was less than 5/3 m and over 0.1 mm was none. The film 101 displayed excellent properties for optical applications. Further, adhesion did not occur after coating (◯), and moisture permeability was excellent (◯). Thus, the present invention is not restricted to the above embodiment, and various changes and modifications are possible in the present invention and may be understood to be within the present invention.

### INDUSTRIAL APPLICABILITY

The dope production method and apparatus, and the film production method of the present invention are applicable to the production of the polymer film for optical applications such as the LCD.

1. A dope production method comprising the step of:
mixing primary dope and an additive, which is added to said primary dope for preparing a dope, by using two inline mixers, which are joined in series and differ in mixing manners, while transporting said primary dope and said additive.

2. A dope production method as claimed in claim 1, wherein one of said inline mixers is a static mixer of a radial mixing type which has plural first elements formed of twisted partition members in a pipe for said transporting.

3. A dope production method as claimed in claim 1, wherein one of said inline mixers is a sulzer mixer of a divide-and-mix type which has plural second elements formed of thin intersecting partition members in a pipe for said transporting.

4. A dope production method as claimed in claim 1, wherein a first inline mixer is a static mixer of a radial mixing type, which has plural first elements formed of twisted partition members in said pipe, and a second inline mixer is a sulzer mixer of a divide-and-mix type, which has plural second elements formed of thin intersecting partition members in said pipe, said inline mixer disposed in a downstream of a position for adding said additive is said sulzer mixer.

5. A dope production method as claimed in claim 4, a distance between an upstream end of said second element in an extreme upstream of said sulzer mixer and said position is from 5 mm to 150 mm.

6. A dope production method as claimed in claim 4, wherein said partition members of said second element in an extreme upstream is inclined 45 degrees in a lengthwise direction at a cross-section of said pipe with respect to a vertical direction of said pipe.

7. A dope production method as claimed in claim 4, wherein said sulzer mixer has a structure in which an upstream end of said second element in an extreme upstream is positioned close to inner walls of said pipe to gather said primary dope added with said additive to a center portion of said second element in said extreme upstream.

8. A dope production method as claimed in claim 1, wherein 1≦V1/V2≦5 is satisfied when a velocity of said additive is V1 and a velocity of said primary dope is V2.

9. A dope production method as claimed in claim 1, wherein an additive ratio of said additive is from 0.1% to 50% with respect to a flow volume ratio.

10. A dope production method as claimed in claim 1, wherein 1000≦N2/N1≦100000 is satisfied when a viscosity of said additive is N1 and a viscosity of said primary dope is N2, and 5000 cP≦N2≦500000 cP and 0.1 cP≦N1≦100 cP are satisfied at 20° C.

11. A dope production method as claimed in claim 1, a shear rate of said primary dope is from 0.1(1/s) to 30(1/s).

12. A film production method comprising the steps of:
producing dope by mixing primary dope and additive added to said primary dope while transporting, using plural inline mixers, which are connected in series and differ in mixing manners; and
forming casting film by casting said dope.

13. A dope production apparatus comprising:
Plural inline mixers joined in series and disposed in a pipe which transports a primary dope and an additive, said adjacent inline mixers differ in mixing manners, said plural inline mixers mix said primary dope and said additive while transporting said primary dope and said additive through said pipe.

14. A dope production apparatus as claimed in claim 13, wherein one of said inline mixers is a static mixer of a radial mixing type which has plural first elements formed of twisted partition members in said pipe.

15. A dope production apparatus as claimed in claim 13, wherein one of said inline mixers is a sulzer mixer of a divide-and-mix type which has plural second elements formed of plural thin intersecting partition members in said pipe.

16. A dope production apparatus as claimed in claim 13, wherein a first inline mixer is a static mixer of a radial mixing type, which has plural first elements formed of twisted partition members in said pipe, and a second inline mixer is a sulzer mixer of a divide-and-mix type which has plural second elements formed of plural thin intersecting partition members in said pipe, said inline mixer disposed in a downstream of a position for adding said additive is said sulzer mixer.

17. A dope production apparatus as claimed in claim 16, wherein a distance between an upstream end of said second element in an extreme upstream of said sulzer mixer and said position is from 5 mm to 150 mm.

18. A dope production apparatus as claimed in claim 16, wherein said partition members of said second element in an extreme upstream is inclined 45 degrees in a lengthwise direction at a cross-section of said pipe with respect to a vertical direction of said pipe.

19. A dope production apparatus as claimed in claim 16, wherein said sulzer mixer has a structure in which an upstream end of said second element in said extreme upstream is located close to inner walls of said pipe to gather primary dope added with said additive to a center portion of said second element in said extreme upstream.

20. A dope production apparatus as claimed in claim 13, wherein said dope production apparatus produces said dope from said primary dope containing cellulose acylate and produces cellulose acylate film.

21. A dope production apparatus as claimed in claim 20, wherein said cellulose acylate film is used as a protection film in a polarizing filter.

22. A dope production apparatus as claimed in claim 21, wherein said polarizing filter is used for LCD devices of VA mode and OCB mode.
